(19) United States
(12) Patent Application Publication
(10) Pub. No.: US 2011/0222024 A1
(43) Pub. Date: Sep. 15, 2011

(54) ILLUMINATION SYSTEM FOR PROJECTION DISPLAY

(75) Inventors: Ho LU, Taoyuan (TW); Shih-Po Yeh, Taoyuan (TW); Peng-Fan Chen, Taoyuan (TW)

(73) Assignee: WALSIN LIHWA CORPORATION, Taoyuan (TW)

(21) Appl. No.: 12/723,870

(22) Filed: Mar. 15, 2010

(51) Int. Cl. G03B 21/28; F21V 1/00; F21V 9/00

(52) U.S. Cl. 353/31; 362/235; 362/231; 353/37

(57) ABSTRACT

An illumination system for a projection display is disclosed in the present invention. The illumination system has three light sources for providing three primary color rays, two collimators for collimating the rays into light beams, and two beam splitters for reflecting and passing the light beams to make white light available. It can also include three light sources, one collimator and three individual beam splitters. The illumination system has a compact size and low manufacturing cost. Its lighting efficiency is better than that of a conventional illumination system. Hence, it is suitable for small size projectors.

### FIELD OF THE INVENTION

The present invention relates to an illumination system for a projection display. More particularly, the present invention relates to an illumination system for a projection display having a reduced size by integrating at least one dichroic mirror or prism.

### BACKGROUND OF THE INVENTION

Generally, a conventional projector is usually composed of a lighting system that uses an UHP lamp, a coloring system, a light valve and an imaging system. Light beams are provided by a light source in the lighting system. Via a rod in the lighting system, light beams can be well unified. Then, the light beams are collimated and sent to the coloring system by a lens (or lenses). The coloring system contains a color wheel which is coated with a special coating. The color wheel can separate primary color light beams from the light source. It can further work with the color valve to generate all colors in sequence. In order for LED projectors to be compact, the lighting system and coloring system can be integrated into one illumination system. By individual light source producing each primary color, the goal is achieved.

The light valve is used to reflect light beams from the coloring system to the imaging system to provide light data (images). For small size projectors, there are three types of light valves which are often used: Liquid crystal on silicon (LCOS) type, LCD High Temperature Poly-Silicon (HTPS) Liquid Crystal Display Panel type and Digital Micro-mirror Device (DMD) type. The imaging system mainly comprises imaging lenses. In order to fit different projecting distances, the lenses have zoom and focus functions.

Please refer to FIG. 1. It illustrates a conventional illumination system 10. The conventional illumination system 10 has a red light source 102, a green light source 104 and a blue light source 106. An X-cube 108 is disposed among the light sources 102, 104 and 106. The red, green and blue beams compose white light and are emitted out of the X-cube 108.

Due to the fact that conventional illumination systems often have separate light sources, their manufacturing cost is high and their size can not be compact, such that they are not suitable for small size projectors.

Color liquid crystal display projectors generate display images and project them onto display screens, typically for viewing by multiple persons or viewers. The display images may be formed by transmitting light from a high-intensity source of polychromatic or white light through an image-forming medium such as a liquid crystal display (LCD).

Conventional liquid crystal display systems include a mosaic of color selective filters positioned over the liquid crystal display element to separate the white light into its constituent color components (e.g., red, green, and blue) to render a full color display. The mosaic of color filters is arranged to provide particular color light components to particular sub-element apertures of the picture elements or pixels in the display.

A disadvantage of such conventional liquid crystal display projection systems is that the mosaic of color selective filters blocks significant amounts of light. In projection display applications, light brightness is an important performance feature.

Therefore, an illumination system of a small size projector having compact size, high brightness, low material cost and easy manufacturing processes is still desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, an illumination system for a projection display includes three light sources for providing first rays, second rays, and third rays, respectively; a first collimator for collimating the first rays into a first light beam and the second rays into a second light beam; a second collimator for collimating the third rays into a third light beam; a first beam splitter for reflecting the first light beam, and passing the second light beam and the third light beam; and a second beam splitter, adjacent to the first beam splitter, for reflecting the second light beam, and passing the third light beam.

Preferably, the light sources are light emitting diodes (LEDs) or laser diodes (LDs).

Preferably, the first beam splitter and the second beam splitter both are non-parallel dichroic mirrors.

Preferably, the dichroic mirrors form an angle smaller than 15° therebetween.

Preferably, the first beam splitter and the second beam splitter are a wedge prism provided with coatings.

Preferably, the first beam splitter and the second beam splitter are two stacked wedge prisms provided with coatings.

Preferably, the wedge prisms have different indices of refraction.

Preferably, the first, second, and third light beams have three different primary colors.

In accordance with an aspect of the present invention, an illumination system for a projection display includes three light sources for providing first rays, second rays, and third rays, respectively; a collimator for collimating the first rays into a first light beam, the second rays into a second light beam, and the third rays into a third light beam; a first beam splitter for reflecting the first light beam, and passing the second light beam and the third light beam; and a second beam splitter, adjacent to the first beam splitter, for reflecting the second light beam, and passing the third light beam; and a reflector, adjacent to the second beam splitter, for reflecting the third light beam.

Preferably, the light sources are light emitting diodes (LEDs) or laser diodes (LDs).

Preferably, the first beam splitter and the second beam splitter are non-parallel dichroic mirrors.

Preferably, the dichroic mirrors form an angle smaller than 15° therebetween.

Preferably, the first beam splitter, the second beam splitter and the reflector are two stacked wedge prisms provided with coatings.

Preferably, the first beam splitter, the second beam splitter and the reflector are three stacked wedge prisms provided with coatings.

Preferably, the wedge prisms have different indices of refraction.

Preferably, the illumination system further includes three condensing lenses for condensing the three light beams from the light sources to the collimator.

Preferably, the illumination system further includes three light guide rods for collecting the three light beams to the collimator.

Preferably, the light guide rods have taper shapes.

Preferably, the light guide rods are hollow.

Preferably, the first, second, and third light beams have three different primary colors.

### BRIEF DESCRIPTION OF THE DRAWINGS

FIG. 1 shows an illumination system of a prior art.

FIG. 2 illustrates an illumination system according to a first embodiment of the present invention.

FIG. 3 illustrates an illumination system according to a second embodiment of the present invention.

FIG. 4 shows a single prism used in the second embodiment.

FIG. 5 illustrates an illumination system according to a third embodiment of the present invention.

FIG. 6 illustrates condensing lenses incorporated into the illumination system in the third embodiment of the present invention.

FIGS. 7A-7B show examples of stacked prisms according to the present invention.

FIG. 8 shows another example of stacked prisms according to the present invention.

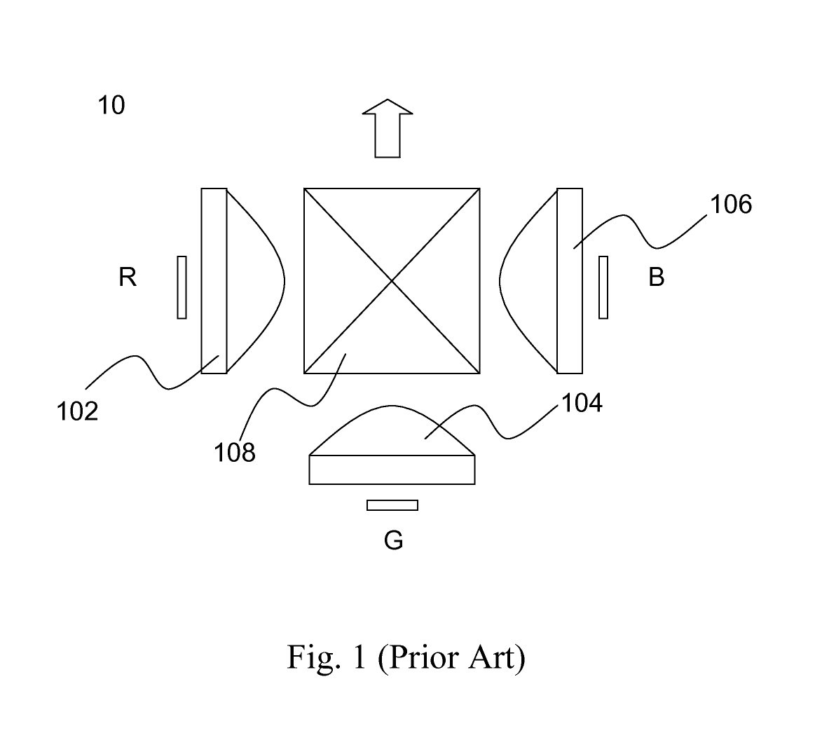

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illumination and description only; it is not intended to be exhaustive or to be limited to the precise form disclosed.

In order to have full understanding of the present invention, three embodiments are described below.

### First Embodiment

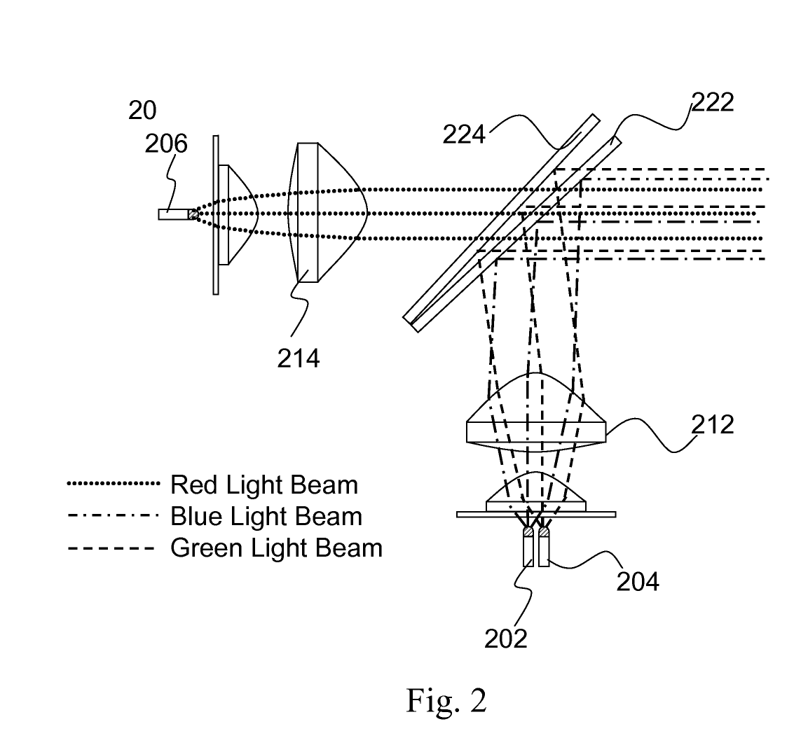

Please refer to FIG. 2. An illumination system 20 for a projection display has a first light source 202, a second light source 204 and a third light source 206. The first light source 202 provides blue rays (shown in chain lines). The second light source 204 provides green rays (shown in dash lines). The third light source 206 provides red rays (shown in dot lines). The light sources 202, 204 and 206 are light emitting diodes (LEDs). In practice, they can be laser diodes (LDs), too.

The illumination system 20 also has a first collimator 212 and a second collimator 214. The first collimator 212 is for collimating the blue rays into a blue light beam and the green rays into a green light beam. The second collimator 214 is for collimating the red rays into a red light beam. A first beam splitter 222 and a second beam splitter 224 are also parts of the illumination system 20. The first beam splitter 222 reflects the blue light beams and passes the green light beams and the red light beams. The second beam splitter 224 formed adjacent to the first beam splitter 222 reflects the green light beams and passes the red light beams. Finally, the red, blue and green light beams propagate in the same direction and a combined white light is formed.

In this embodiment, the first beam splitter 222 and the second beam splitter 224 are both dichroic mirrors. The angle between the two dichroic mirrors (i.e., the first beam splitter 222 and the second beam splitter 224) is smaller than 15°.

Each light source of a traditional illumination system is provided with a corresponding collimator (i.e., including totally three collimators), thereby causing the traditional illumination system to be large in size. The illumination system of the present invention has a smaller size by reducing the amount of collimators used. In this embodiment, the illumination system includes only two collimators which successfully minimize the overall size of the illumination system.

### Second Embodiment

According to the present invention, the dichroic mirrors in the first embodiment can be replaced with two wedge prisms stacked together. The two wedge prisms have different indices of refraction. Similar to the first embodiment having three light sources and two collimators, the second embodiment has the same elements which have the same functions. Hence, descriptions of these elements are omitted. Only how the two wedge prisms works to provide combined light beams is described below.

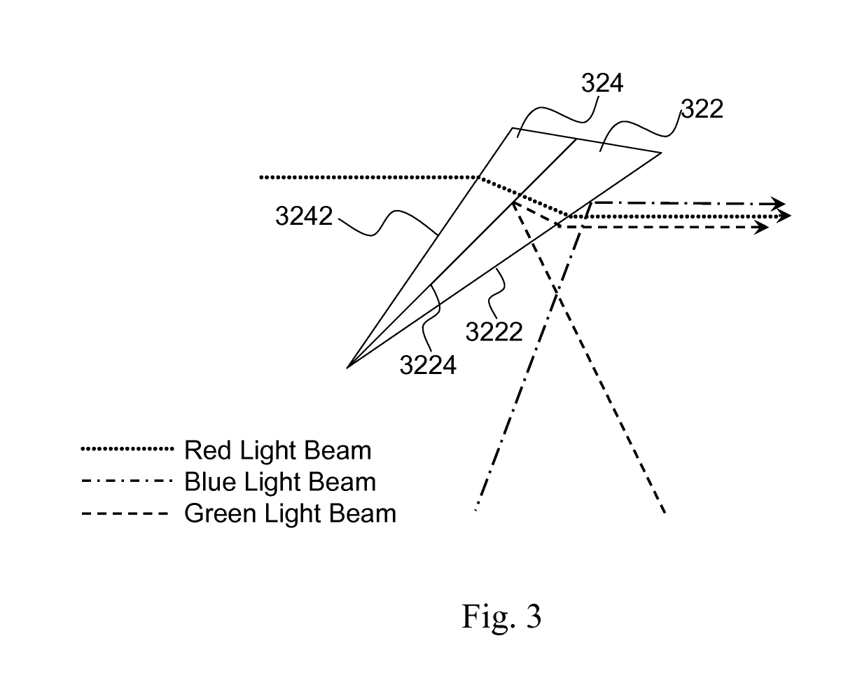

Please refer to FIG. 3. It shows a first wedge prism 322 and a second wedge prism 324 of the present embodiment. For better understanding, the wedge prisms 322 and 324 have three faces: a first face 3222, a second face 3224 and a third face 3242. The first face 3222 is a surface of the first wedge prism 322. The second face 3224 is an interface of the first wedge prism 322 and the second wedge prism 324. The third face 3242 is a surface of the second wedge prism 324. Faces 3222 and 3224 have coatings thereon for acting as beam splitters.

When a blue light beam (chain line) illuminates the first wedge prism 322, it will be reflected by the first face 3222. When a green light beam (dash line) illuminates the first wedge prism 322, it can pass the first face 3222. However, the green light beam will be reflected by the second face 3224 then transmits out of the first wedge prism 322 from the first face 3222. When a red light beam (dot line) illuminates the second wedge prism 324 via the third face 3242, it will be refracted, pass the second wedge prism 324, enter the first wedge prism 322 via the second face 3224, and finally leave the first wedge prism 322 from the first face 3222. Similarly, the red, blue and green light beams propagate in the same direction and a combined white light is formed. The two prisms 322 and 324 works as the two dichroic mirrors in the first embodiment.

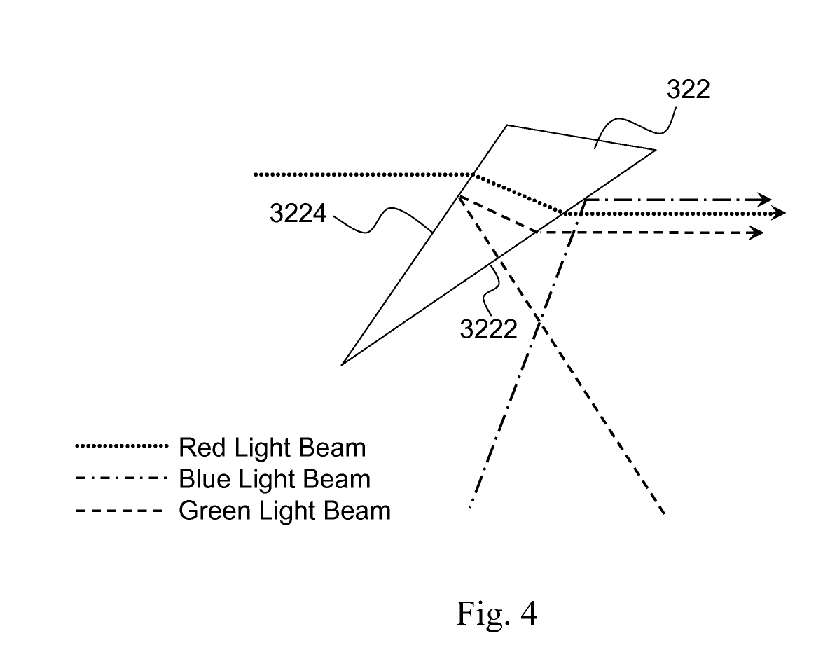

As mentioned above, the second face 3224 is an interface of the first wedge prism 322 and the second wedge prism 324. In this embodiment, the second face 3224 is a surface of the second wedge prism 324 which has a coating thereon. Alternatively, the two wedge prisms 322 and 324 can be replaced by one single wedge prism by applying such coating on a surface of the first wedge prism 322, as shown in FIG. 4. In other words, coatings are applied to two surfaces of a wedge prism while only one wedge prism is used, and a coating is applied to a single surface of every wedge prism while two wedge prisms are used as two beam splitters.

When a blue light beam (chain line) illuminates the first wedge prism 322, it will be reflected by the first face 3222. When a green light beam (dash line) illuminates the first wedge prism 322, it can pass the first face 3222. However, the green light beam will be reflected by the second face 3224 then transmits out of the first wedge prism 322 from the first face 3222. When a red light beam (dot line) illuminates the first wedge prism 322 via the second face 3224, it will be refracted, pass the first wedge prism 322 and finally leave the first wedge prism 322 from the first face 3222. A combined light can also be formed by this way. Therefore, one single prism or two stacked prisms have the same beam splitter function.

Similar to the first embodiment, the illumination system of the second embodiment includes only two collimators for minimizing the overall size of the illumination system. Differentiated from the first embodiment utilizing dichroic mirrors as beam splitters, at least one prism is introduced in the second embodiment for providing beam splitter function.

### Third Embodiment

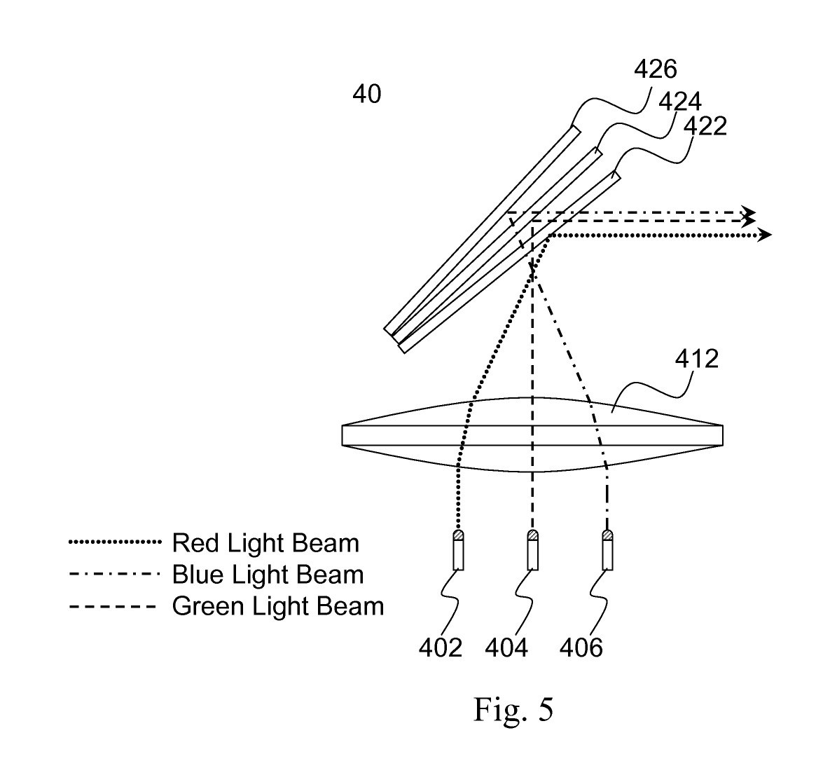

Please see FIG. 5, a third embodiment is illustrated. An illumination system 40 for a projection display comprises a first light source 402, a second light source 404, a third light source 406, a collimator 412, a first beam splitter 422, a second beam splitter 424 and a reflector 426. The first light source 402 provides red light beams. The second light source 404 provides green light beams. The third light source 406 provides blue light beams. The collimator 412 is for collimating the red, green and blue light beams. The first beam splitter 422 reflects the red light beams and passes the green and blue light beams. The second beam splitter 424 fabricated adjacent to the first beam splitter 422 reflects the green light beams and passes the blue light beams. The reflector 426 provided adjacent to the second beam splitter 424 reflects the blue light beams. A combined white light can be formed by this way.

In this embodiment, the light sources 402, 404 and 406 are light emitting diodes. Laser diodes can also be alternative. The first beam splitter 422 and the second beam splitter 424 are non-parallel dichroic mirrors. Any two adjacent dichroic mirrors have an angle preferably smaller than 15°. Like the second embodiment, the first beam splitter 422, the second beam splitter 424 and the reflector 426 can be replaced with two or three stacked wedge prisms. Coatings are provided on surfaces of the wedge prisms of different indexes of refraction for providing beam splitter function.

In other words, dichroic coatings can be applied to a single surface of a first wedge prism and two surfaces of a second wedge prism while two wedge prisms are used, or a single surface of every wedge prism while three wedge prisms are used as three beam splitters.

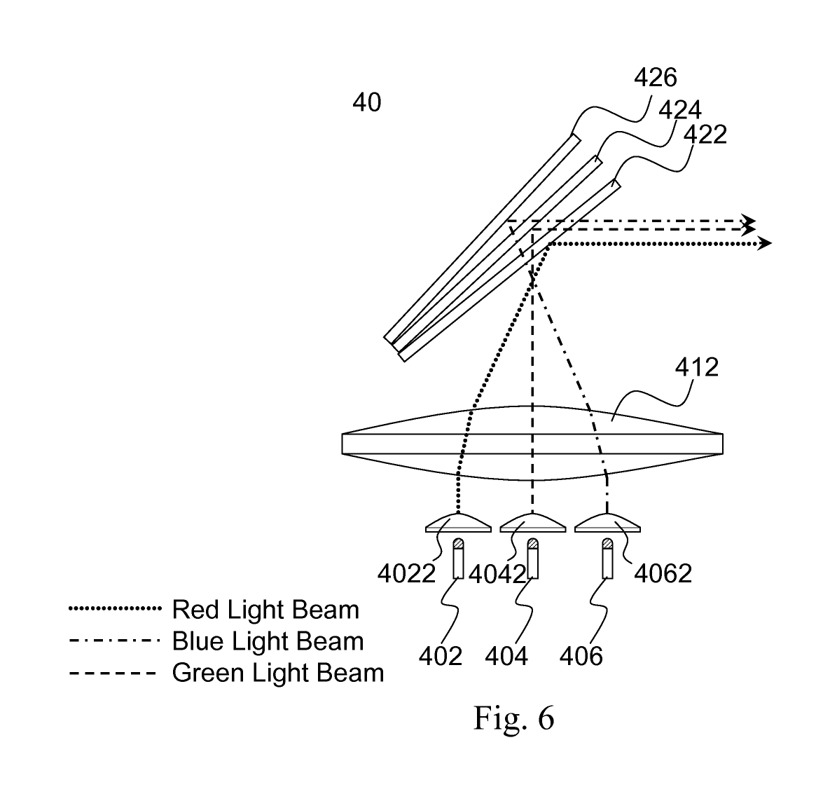

Please refer to FIG. 6. According to the present invention, a first condensing lens 4022, a second condensing lens 4042 and a third condensing lens 4062 are used for condensing the three light beams to the collimator 412. Alternatively, the condensing lenses 4022, 4042, 4062 can be replaced with light guide rods which may be either solid or hollow (i.e., tunnel). Preferably, the light guide rods have taper shapes.

Differentiated from the first and second embodiments including two collimators, the illumination system of the third embodiment has only one collimator which forms a smaller illumination system than those of the first and second embodiments.

In the present invention, the first, second, and third light sources are not limited to the colors designated above. For example, the first, second, and third light sources may provide red, blue, and green rays, respectively.

Although dichroic mirrors and wedge prisms are separately used in the aforementioned embodiments, they can also be combined together. For example, the coating applied on the second surface 3224 of the wedge prism 322 shown in FIG. 4 can be replaced with a dichroic mirror. In other words, a beam splitter can be provided by applying a dichroic coating on a prism or using a dichroic mirror. Similarly, the reflector can be provided by applying a reflective coating on a prism or using a reflective mirror.

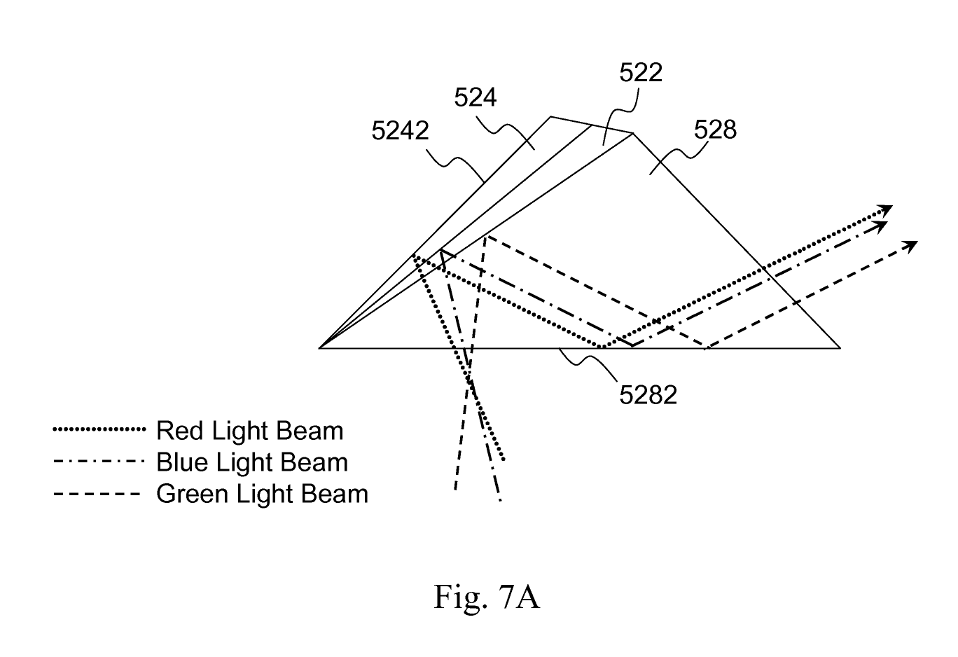

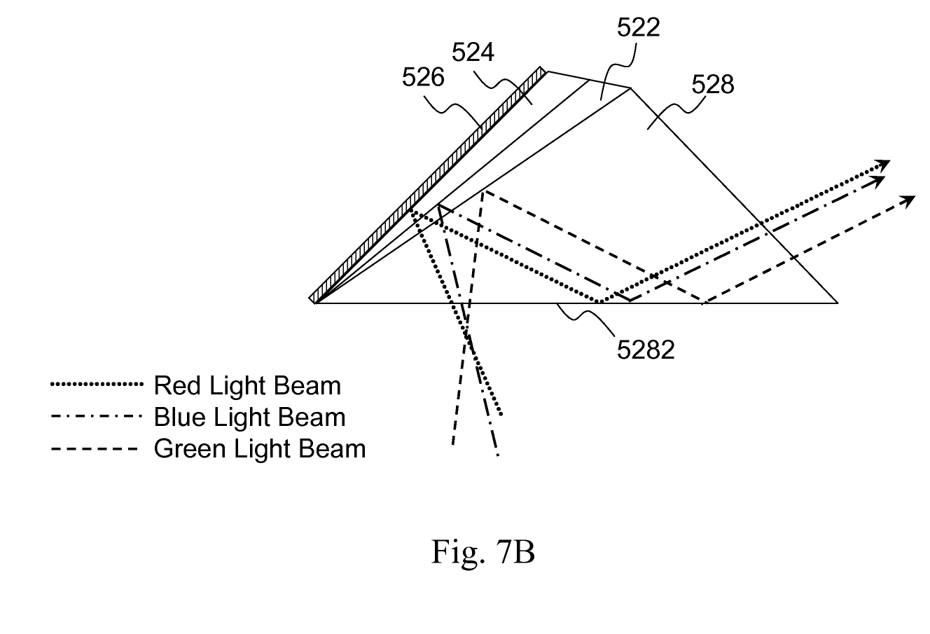

Furthermore, propagating directions of the light beams emitting from the prism can be adjusted by an additional prism. For example, as shown in FIG. 7A, an additional prism 528 is placed adjacent to two stacked wedge prisms 522 and 524. The two stacked wedge prisms 522 and 524 are used to combine light beams of different directions into one so that the light beams can propagate in the same direction, and the additional prism 528 is used to adjust the light beams to propagate in upper-right direction.

As mentioned above, the reflector can be provided by applying a reflective coating on a prism or using a reflective mirror. In FIG. 7A, reflective coatings are applied on a surface 5242 of the wedge prism 524 for reflecting red light beams and a surface 5282 of the additional prism 528 for totally reflecting red, green, and blue light beams. In FIG. 7B, a reflective mirror 526 is provided adjacent to the wedge prism 524 for reflecting light beams passing through the wedge prism 524.

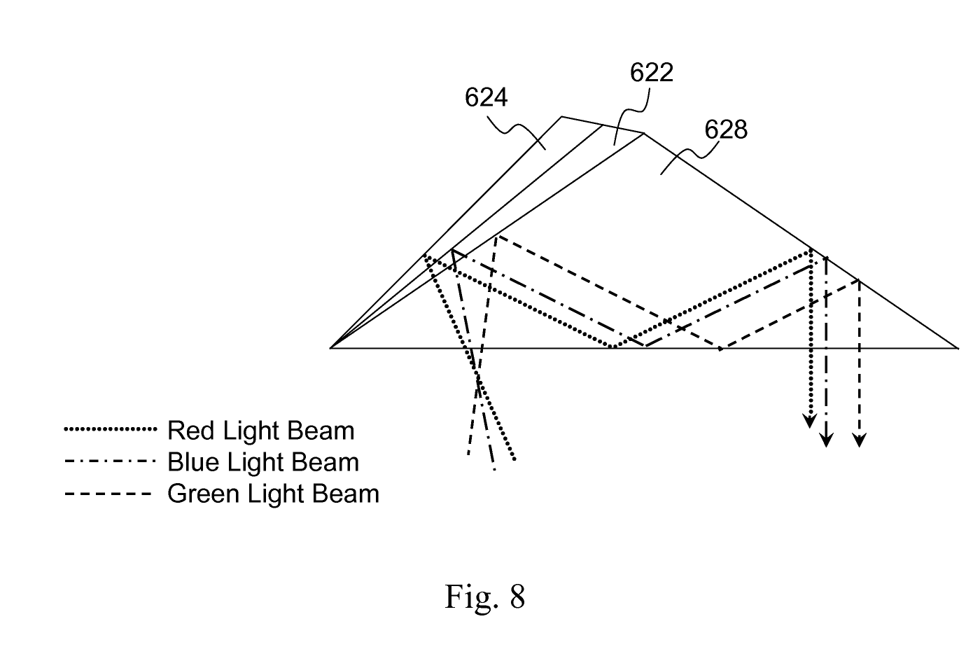

Alternatively, an additional prism 628, placed adjacent to two stacked wedge prisms including a first wedge prism 622 and a second wedge prism 624, can also be shaped as shown in FIG. 8, which allows light beams to propagate downwards.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An illumination system for a projection display, comprising:
three light sources for providing first rays, second rays, and third rays, respectively;
a first collimator for collimating said first rays into a first light beam and said second rays into a second light beam;
a second collimator for collimating said third rays into a third light beam;
a first beam splitter for reflecting said first light beam, and passing said second light beam and said third light beam; and
a second beam splitter, adjacent to said first beam splitter, for reflecting said second light beam, and passing said third light beam.

2. The illumination system according to claim 1, wherein said light sources are light emitting diodes (LEDs) or laser diodes (LDs).

3. The illumination system according to claim 1, wherein said first beam splitter and said second beam splitter both are non-parallel dichroic mirrors.

4. The illumination system according to claim 3, wherein said dichroic mirrors form an angle smaller than 15° therebetween.

5. The illumination system according to claim 1, wherein said first beam splitter and said second beam splitter are a wedge prism provided with coatings.

6. The illumination system according to claim 1, wherein said first beam splitter and said second beam splitter are two stacked wedge prisms provided with coatings.

7. The illumination system according to claim 6, wherein said wedge prisms have different indices of refraction.

8. The illumination system according to claim 1, wherein said first, second, and third light beams have three different primary colors.

9. An illumination system for a projection display, comprising:
three light sources for providing first rays, second rays, and third rays, respectively;
a collimator for collimating said first rays into a first light beam, said second rays into a second light beam, and said third rays into a third light beam;
a first beam splitter for reflecting said first light beam, and passing said second light beam and said third light beam; and
a second beam splitter, adjacent to said first beam splitter, for reflecting said second light beam, and passing said third light beam; and
a reflector, adjacent to said second beam splitter, for reflecting said third light beam.

10. The illumination system according to claim 9, wherein said light sources are light emitting diodes (LEDs) or laser diodes (LDs).

11. The illumination system according to claim 9, wherein said first beam splitter, said second beam splitter are non-parallel dichroic mirrors.

12. The illumination system according to claim 11, wherein said dichroic mirrors form an angle smaller than 15° therebetween.

13. The illumination system according to claim 9, wherein said first beam splitter, said second beam splitter and said reflector are two stacked wedge prisms provided with coatings.

14. The illumination system according to claim 13, wherein said wedge prisms have different indices of refraction.

15. The illumination system according to claim 9, wherein said first beam splitter, said second beam splitter and said reflector are three stacked wedge prisms provided with coatings.

16. The illumination system according to claim 15, wherein said wedge prisms have different indices of refraction.

17. The illumination system according to claim 9, further comprising three condensing lenses for condensing said three light beams from said light sources to said collimator.

18. The illumination system according to claim 9, further comprising three light guide rods for collecting said three light beams to said collimator.

19. The illumination system according to claim 18, wherein said light guide rods have taper shapes.

20. The illumination system according to claim 18, wherein said light guide rods are hollow.

21. The illumination system according to claim 9, wherein said first, second, and third light beams have three different primary colors.
